(19) United States
(12) Patent Application Publication
(10) Pub. No.: US 2022/0339634 A1
(43) Pub. Date: Oct. 27, 2022

(54) Plastic Bottle Crusher

(71) Applicant: Lothar Budike, JR., Villanova, PA (US)

(72) Inventor: Lothar Budike, JR., Villanova, PA (US)

(21) Appl. No.: 17/240,995

(22) Filed: Apr. 26, 2021

(51) Int. Cl. B02C 4/42; B02C 4/30; B02C 19/00

(52) U.S. Cl. CPC B02C 4/42; B02C 4/30; B02C 19/0093

(57) ABSTRACT

The invention is a plastic bottle crusher that includes a vacuum nozzle creating suction to compress the bottle via a manual pump or electric motor and a series of cutting blades in order to chop and shred plastic bottles of multiple sizes. The invention also includes an excess water chamber as well as variable sized detachable sleeves based on bottle size with mechanical blades to remove bottle labels as well as a vertical guide to provide maximum compression for air removal, plastic preparation for recycling and placement of crushed bottles into a recyclable housing.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND OF INVENTION

### A. Field of the Invention

More than half of the people in the United States drink plastic bottled water regularly. In general, bottled water is considered convenient because it is portable. But that convenience comes with problems and a high environmental cost. The problems with plastic bottles include the pollution created during production and transportation of bottled water, injuries to marine life from discarded bottles and garbage dumps filled with empty bottles. Plastic water bottles are typically made from crude oil. During their production, pollutants such as nickel, benzene, and ethylene oxide are released. These harm the environment and pollute the air we breathe.

There are 26 billion plastic water bottles are made each year. That equals 30 million tons of plastic. Unfortunately, most bottles end up in garbage dumps rather than recycling centers. It takes hundreds of years for a plastic bottle to decompose. The bottles that are in the garbage dumps today will be with us a long time. Currently only about 30 percent of plastic bottles make it to a recycling center. 70 percent wind up in garbage dumps. The present invention is designed to provide consumers a more efficient way to increase the recycling rates of plastic bottles. It enables a consumer to “process” their own plastic bottles prepare and pack their plastic in order to immediately be paid for the plastic by fast track recycling to alleviate plastic bottles being thrown in landfills and the trash.

The present invention is directed to a device and process to crush and prepare plastic bottles for recycling, more particular a system that compresses and shreds various sizes of plastic bottles. The invention relates to the field of a bottle crushing apparatus, more specifically, a plastic bottle crusher that includes both compression through a nozzle for suction and shredding through various blades. In addition, the device has a detachable water filtration device for excess water and a detachable lower sleeve that accommodates multiple size bottles while extracting labels and slide guide for maximum air extraction.

### B. Discussion of the Prior Art

Container compression mechanisms have been patented in the past, mostly were designed for use with aluminum cans and plastic bottles. These devices all followed a simple design that utilized a “clam shell” hinge along with a manual lever approach to crush the bottle or can through this mechanical or electrical process. None of the prior patented devices utilized a combination of simultaneous vacuum suction and shredding blades to transform the bottle into recyclable material, pack it and dispose it for direct sales to plastic recyclers.

All prior patented mechanisms suited for use with either an aluminum can or plastic bottle had the same design and operation. The present invention seeks to overcome this disadvantage by utilizing a new method for crushing the bottle and adding features to prepare the bottle for recycling. There is an ample prior art that deals with bottle crushers. No prior art discloses a bottle crusher that utilizes suction and shredding to compress bottles nor offer features such as liquid filtration, label remover and vertical guide to crush the plastic bottles of various sizes for packaging and shipment.

The Powell patent (U.S. Pat. No. 8,104,401) discloses a plastic bottle “clam shell” crushing mechanism which has a vertical arrangement and is operable by the hand or through mechanical means. However, unlike the older prior art, the mechanism provides a tray area for liquid to drain at the bottom to collect remaining liquids contained within the object to be crushed.

The Geise patent (U.S. Pat. No. 6,076,455) discloses a “Clam Shell” aluminum can crushing mechanism which has a vertical arrangement and is operable by the hand. However, the crushing mechanism is directed to use with aluminum cans, and does not utilize suction and or shredding blades for the object to be crushed.

The Maki et al. patent (U.S. Pat. No. 5,848,569) discloses a can crusher that moves from an open to a closed position. Again, the crushing mechanism is “Clam Shell” and designed for use with a can, preferably aluminum, and of which does not utilize suction and or shredding blades for the object to be crushed.

The Belfils patent (U.S. Pat. No. 4,133,261) discloses a beverage container crusher that the crushing mechanism is “Clam Shell” and does not utilize suction and or shredding blades for the object to be crushed.

The Woodard patent (U.S. Pat. No. 3,980,015) discloses a device for crushing cans having two crushing members having handles. Again, the crushing mechanism is “Clam Shell” and designed for use with a can, preferably aluminum, and of which does not utilize suction and or shredding blades for the object to be crushed.

The Wilson et al. patent (U.S. Pat. No. 2,800,160) discloses a device for flattening cans that is mountable. Again, the device is designed for use with a can and does not utilize suction and or shredding blades for the object to be crushed.

### SUMMARY OF THE INVENTION

This apparatus is a plastic bottle crusher. The bottle crusher shell can be in multiple shapes such as cylindrical or rectangular in shape with a top assembly and a bottom assembly. The top assembly has a power switch and a power supply which can be a battery pack and may also have an electric port such as a USB port. The top assembly would have an exhaust air flow vent on the top to exhaust excess air generated form the vacuum pressure. The top assembly would have the power supplies that would be attached to one or motors, a vacuum motor which drives a vacuum blade and a blade motor which drives chopping blades. The chopping blades can be used to shred the plastic bottle.

The top assembly would have an water filtration mechanism in order to drain out any excess liquids from the top assembly. The top assembly will also have a modulating vacuum nozzle on which the plastic bottle will attached. The pressurized modulating nozzle will create a steady controlled vacuum along with a lower vertical slide detachable base that will force the bottle to be compacted and collapse the plastic bottle vertically onto it self rather than creating an elongated collapse.

The bottom assembly will have a label scrapper and retractable alignment rollers. It will also have a spring loaded retractable mount which will place upward pressure on the plastic bottle. A further object of the invention is to provide a plastic bottle crusher that is either manually operated or operated by an automated mechanical or electrical system. A further object of the invention is to provide a plastic bottle crusher that is lightweight, effective, easy to operate, and affordable.

In this respect, it is to be understood that the plastic bottle crusher is not limited in its upright position and can be inverted upside down or spun around for various positions and can be mounted to the side of a trash bin or table top for direct access to the recycle trash rather than being hand held. In addition, it is not limited in its applications to the details of construction and arrangements of the components set forth in the following description or illustration.

Those skilled in the art will appreciate that the concept of this disclosure may be readily utilized as a basis for the design of other structures, methods, and systems for carrying out the several purposes of the plastic bottle crusher. It is therefore important that the claims be regarded as including such equivalent construction insofar as they do not depart from the spirit and scope of the plastic bottle crusher. It is also to be understood that the phraseology and terminology employed herein are for purposes of description and should not be regarded as limiting.

### BRIEF DESCRIPTION OF THE DRAWINGS

Without restricting the full scope of this invention, the preferred form of this invention is illustrated in the following drawings:

FIG. 1 is an exterior view of a configuration of the bottle crusher constructed in accordance with the present invention;

FIG. 2 is an interior view of a configuration of the bottle crusher constructed in accordance with the present invention;

FIG. 3 is a top view of the bottle crusher constructed in accordance with the present invention;

FIG. 4 is a view of the bottom components of the bottle crusher constructed in accordance with the present invention;

FIG. 5 is a view of the top components of the bottle crusher constructed in accordance with the present invention;

FIG. 6 is a view of the roller cutters constructed in accordance with the present invention;

FIG. 7 shows a view of the retractable alignment rollers constructed in accordance with the present invention;

FIG. 8 shows a plastic bottle being crushed constructed in accordance with the present invention;

FIG. 9 shows a view of various bottom assemblies that would accommodate various sizes of plastic bottles based on width of the plastic bottles constructed in accordance with the present invention;

FIG. 10 a-c shows a view of the crusher packing plastic transportation sleeve for recycle constructed in accordance with the present invention;

FIG. 11 show a set of packing plastic transportation sleeves in a shipping box;

FIG. 12 shows a view of the side mount clip attaching to the top edge of a trash or recycle bin; and

FIG. 13 shows a view of the table mount clip attaching to the side edge of a commercial or residential table.

### DETAILED DESCRIPTION OF THE PREFERRED EMBODIMENTS

There are a number of significant design features and improvements incorporated within the present invention.

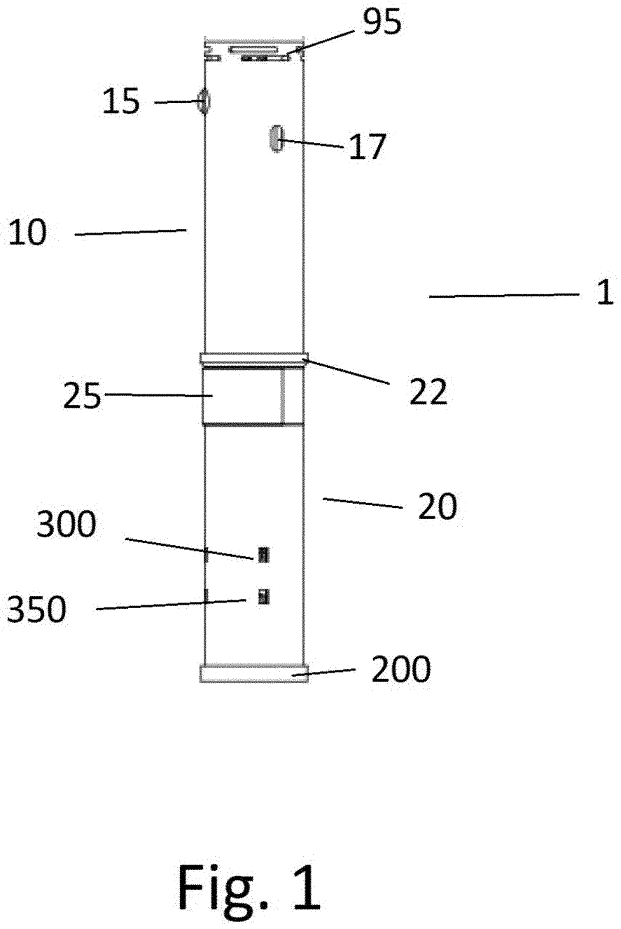

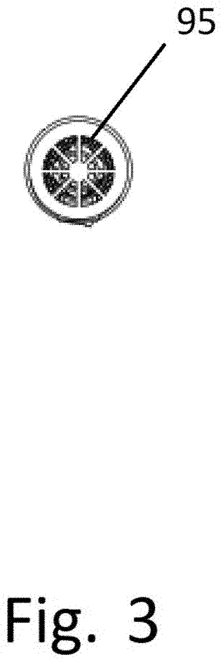

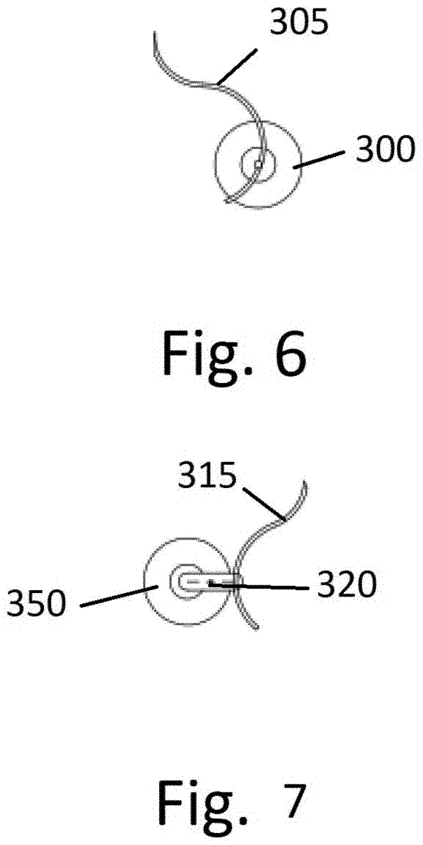

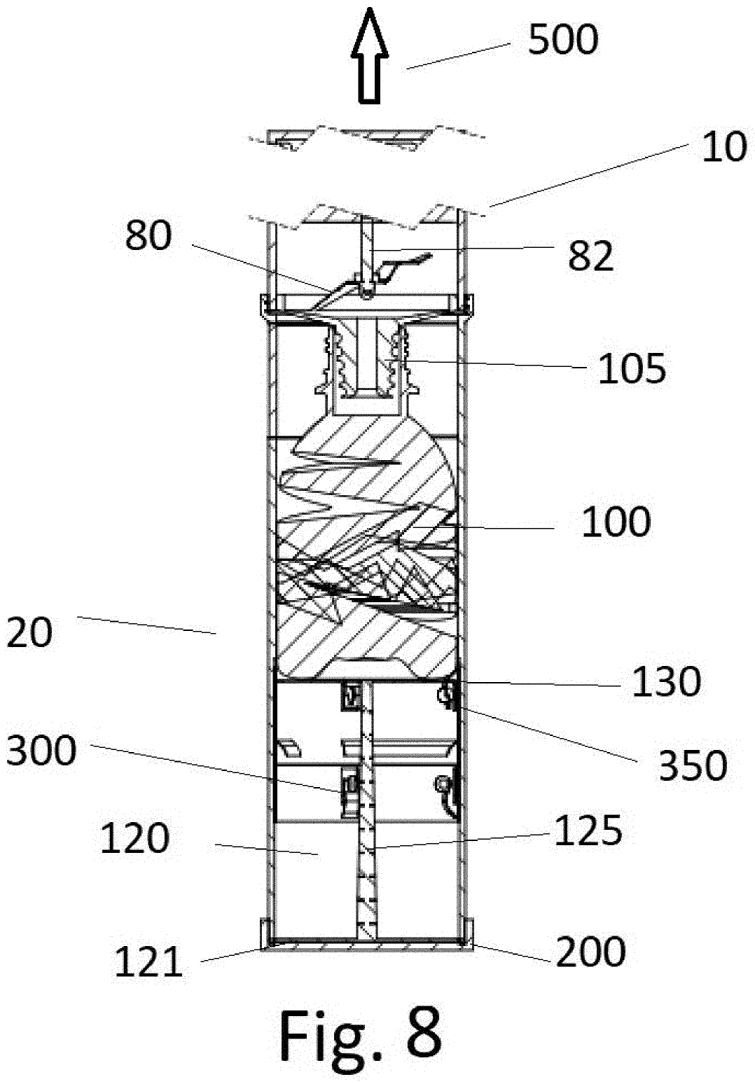

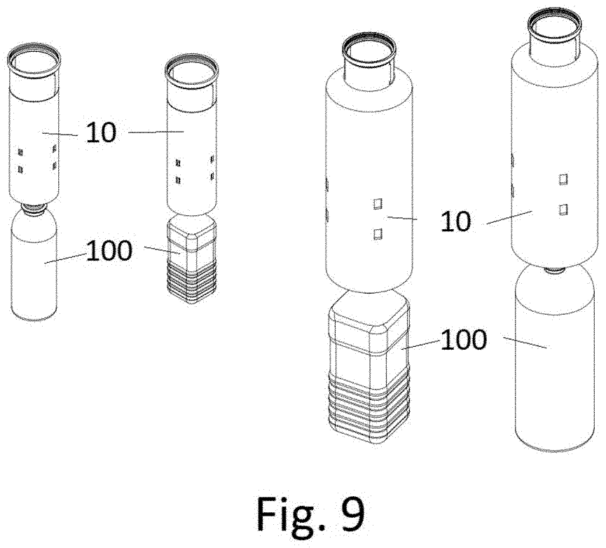

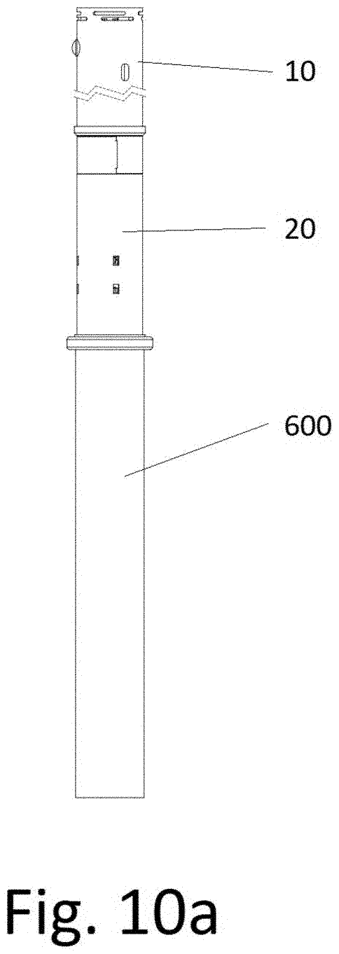

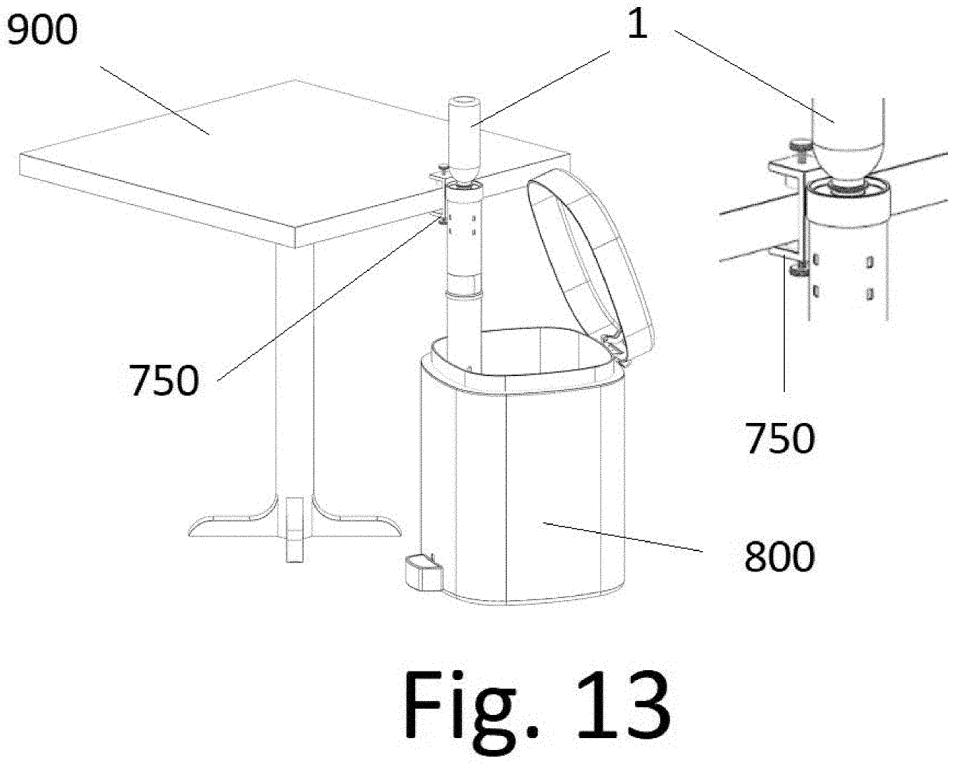

As shown in FIGS. 1-13, the current invention is a device that is a plastic bottle crusher 1.

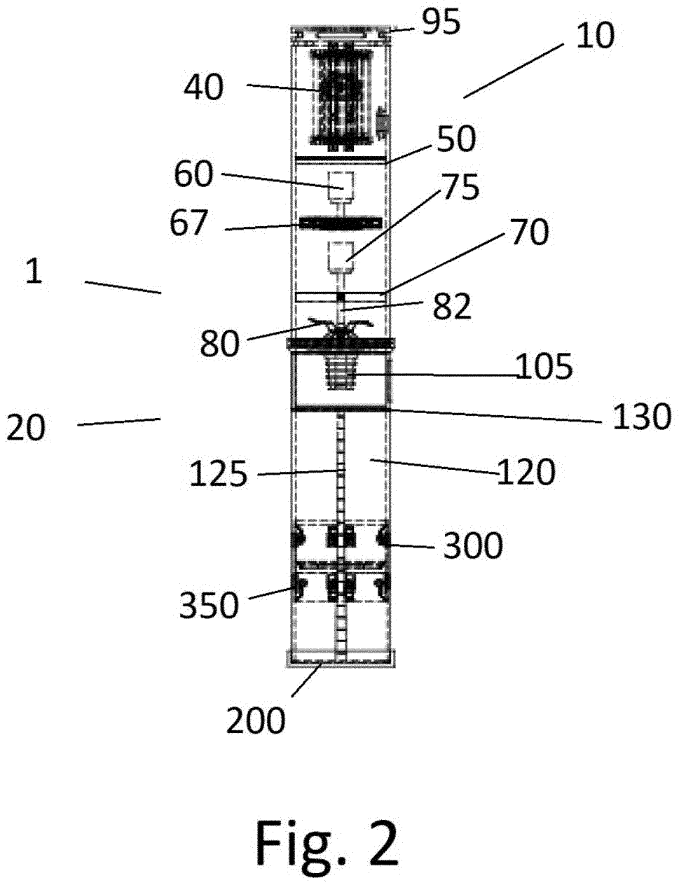

In the preferred embodiment the bottle crusher 1 is cylindrical in shape but it can be built in any suitable shape such as rectangular with a top assembly 10 and a bottom assembly 20. The top assembly 10 contains the bottle crushing and shredding components while the bottom assembly 20 contains components that make the bottle crusher more efficient for compacting and recyclable transport. The bottle crusher 1 can work with only the top assembly 10. The top assembly 10 and the bottom assembly 20 both have shells which are detachable and can be made of a light metal such as aluminum or plastic as shown in FIGS. 1 and 2.

The top assembly 10 has a power switch 15 and a power supply 40 which can be a A/C DC converter power supply module or a series of batteries in a pack with charging circuit. The bottle crusher 1 may also have both a variable (115 to 220) AC power transformer or an exterior power supply via a USB port 17. The power supplies would be attached to one or more motors, a vacuum motor 60 and a blade chopping motor 75 as shown in FIGS. 1, 2 and 5.

The vacuum motor 60 drives the vacuum fan blades 67 and are attached to a vacuum motor shaft 65 which is attached to the vacuum motor 60. The vacuum motor 60 drives the vacuum motor shaft 65 which turns the vacuum fan blades 67 creating an upward air flow 500 towards the top of the main assembly 10 creating a vacuum as shown in FIGS. 1, 2, 5 and 8.

Other vacuum system designs can be used instead of fan assemblies such a using manual pump, electromechanical, rotor or hydraulics to form the vacuum.

The power supply 40 is separated from the vacuum motor 60 by an exhaust vacuum filter 50 which allows for one way air flow out from the chamber that contains the vacuum motor 60 and vacuum fan blades 67. There is an exhaust air flow vent 95 at the top of the main assembly 10 or the bottle crusher 1 as shown in FIGS. 1, 2, 3 and 5.

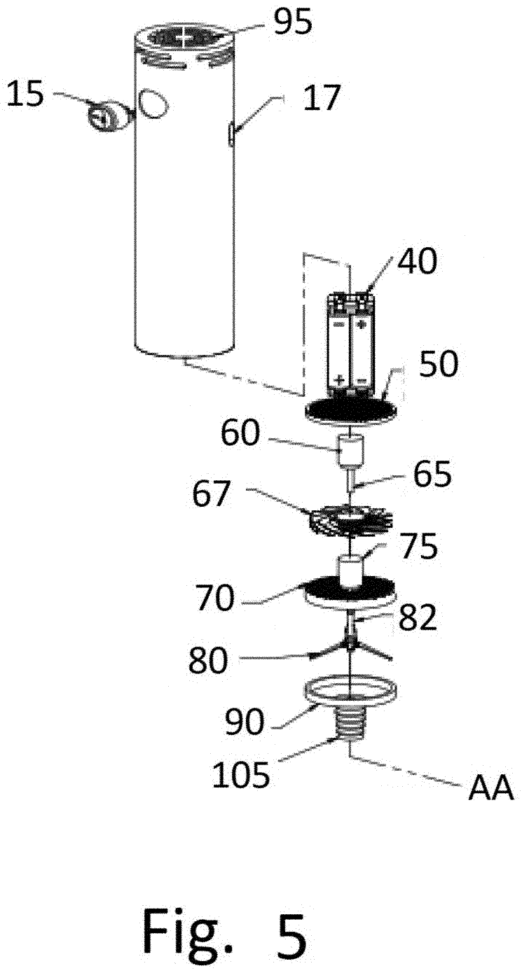

The blade chopping motor 70 is below the vacuum fan blades 67 in the preferred embodiment, as shown in FIGS. 2 and 5. The blade chopping motor 70 is connected to the chopping shaft 82. The chopping shaft 82 had several chopping blades 80 at the end. The chopping blades 80 are connected to the chopping shaft 82 by a pivot in the preferred embodiment allowing them to hang straight down when not in use allowing them to enter into the plastic bottle 100 through the vacuum nozzle 105. The chopping blades 80 extend away from the chopping shaft 82 by centrifugal forces when the chopping shaft 82 is spinning causing the chopping blades 80 to chop or shred the plastic bottle 100. The chopping blades 80 will have a slicing edge to chop up the plastic bottle 100. The chopping blades 80 can be used to chop up and shred the plastic bottle 100 as shown FIGS. 2, 4, 5, and 8.

In an alternative embodiment, other shredding means can be facilitated through a straight blade or a round retractable blade 300 which would be mounted to the inside walls of the bottom assembly 20 shredding the bottle as it rises from the vacuum from the interior of the bottom assembly 20 as shown in FIGS. 1, 2, 4, 6 and 8.

The top assembly 10 will have an adjustable suction head 90 at the bottom of the top assembly 10 closing it. The adjustable suction head will be designed to modulate and accommodate various bottle widths and plastic thicknesses in order to maximize the vacuum suction to most efficiently crush the bottle. The adjustable suction head 90 will have a nozzle 105 that extends away from the adjustable section head 90. The nozzle 105 be wider at it base where it connects to the adjustable section head 90 and tappers inward as it extends out. The plastic bottle's neck will fit onto the nozzle 105 with the tapered shape the nozzle 105 will be able to fit into any size bottle neck as shown in FIGS. 1, 2, 5 and 8.

There is a water vacuum filter 70 positioned between the blade chopping motor 75 and the adjustable section head 90. This water vacuum filter 70 collects all excess water and moisture being sucked up by the suction within the system. The filter also keeps water and any particulates from entering the bottle crusher 1 and its vacuuming system as shown in FIGS. 1, 2, and 5.

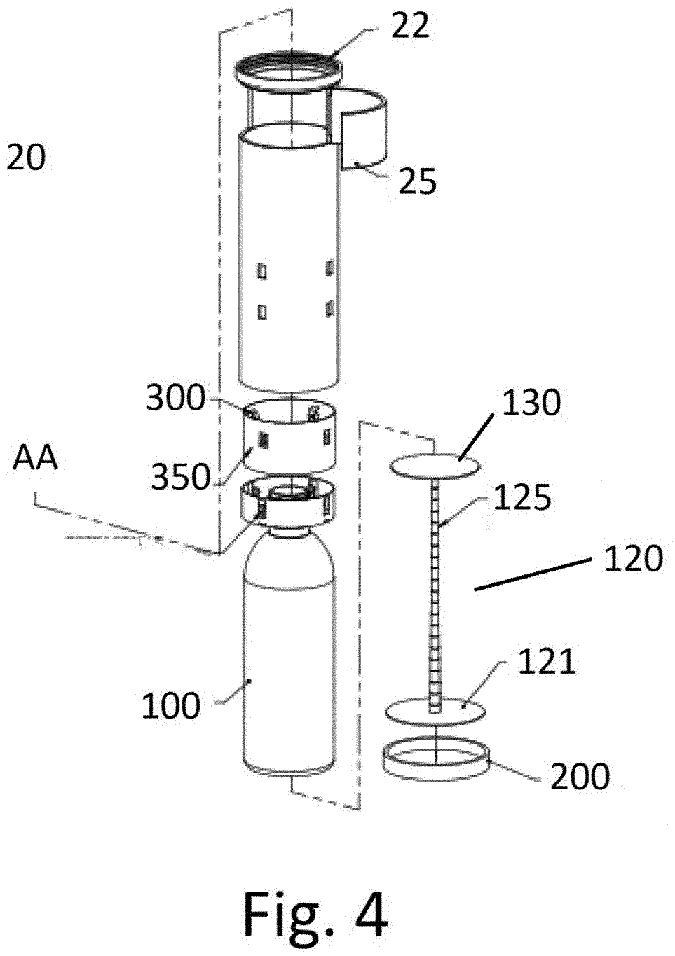

As shown in FIG. 1, the bottom assembly 20 has a shell also made of a lightweight material such as aluminum or plastic. In the preferred embodiment, it will attach or screw on to the top assembly 10 using an attachment such as a screw on rim 22 as shown in FIG. 4. At the top side of the bottom assembly 20 there will be an transparent plastic access door 25. This access door will show users that the bottle neck has connected with the plastic nozzle 105. The access door 25 can also be opened to extract excess water and shredded plastic. The access door 25 will have hinges and will open outwardly as shown in FIGS. 1, 2 4, and 8.

As shown in FIGS. 2, 4 and 6, the bottom assembly 20 will have a section of roller razors 300 which are designed to cut the plastic bottle 100 into smaller plastic sections. The roller razors 300 will be attached to a roller razer tension spring 305 which in the preferred embodiment is a bent metal filament which provides an inward tension towards the plastic bottle 100 allowing for cutting as shown in FIGS. 1,2 4, 6, 7 and 8.

The bottom assembly 20 will also have a set of retractable alignment rollers 300 as shown in FIGS. 2, 4 and 7. These alignment rollers 300 will extend inward from the bottom assembly 20 inner wall and will align and center the plastic bottle 100 for the bottle crusher 1. In the preferred embodiment the retractable alignment rollers will be circular in shape and be attached to an alignment bar 320 which is attached to a spring unit 315 which provides a slight inward pressure that will aid the bottle to collapse onto itself rather than a vertical crush for the smallest possible compact bottle as shown in FIGS. 1, 2 4, 6, 7 and 8.

The bottom assembly 20 will have one or more label scrappers 350 that extend out from the interior of the bottle part cylinder. The label scrappers 350 catch the label of the plastic bottles 100 and scrap them off so that only the plastic bottle 100 is prepared for recycling as shown FIGS. 1, 2, 4, 6 and 8.

Once the plastic bottle 100 is placed in the bottom assembly cylinder in the preferred embodiment an end cap 200 is placed on the bottom of the bottle part cylinder. On top of the end cap 200 a spring loaded retractable mount 120 is attached. It can be part of the end cap 200 or a separate component. The spring loaded retractable mount 120 will have a spring mechanism 125 attached to either the end cap 200 or its on base 121 that is placed in the end cap 200. On top of the spring mechanism 125 is a mount 130. The mount 130 will placed on the plastic bottle 100 after it is loaded which will place additional upward pressure on the plastic bottle 100 in order for the plastic to compress onto itself rather than crushing the bottle in a vertical direction which does not maximize the compression and reduce the size of the plastic bottle as shown in FIGS. 1, 2, 4, and 8

The bottom assembly 20 and mount 22 sleeve will be designed in various widths to accommodate larger width plastic bottles and will also come in both in round and square shapes in order to in order to accommodate a range vertical plastic bottles as shown in FIGS. 1, 2, 4 and 9.

The bottom assembly 20 will have a detachable sleeve bags 600 to store the compressed and or shredded bottles 610. These sleeves will be collected in a case 700 used to collect the excess plastic ready to be exchanged for cash or credit when exchanged with purchasers of recycle plastics. These payments will create the incentive to exchange and recycle as shown in FIG. 1, 2, 10a, 10b 10c 11

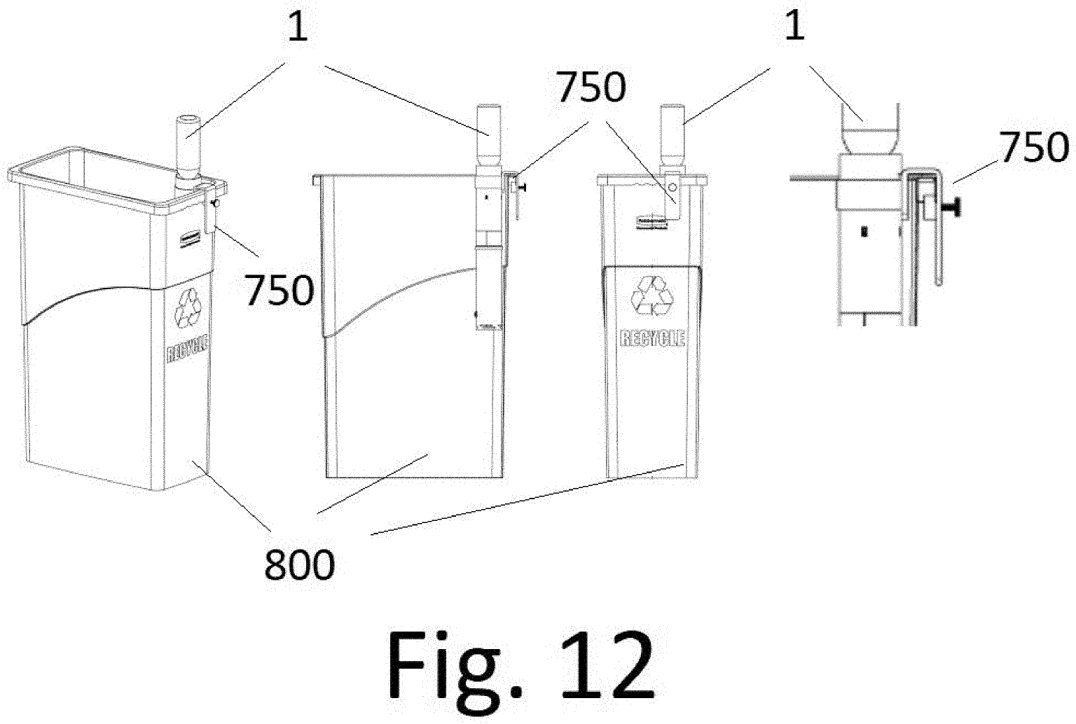

The bottom assembly 20 will have a clip attachment 750 design to attach the bottle crusher to the side of a trash can 800 as well as to the side of a commercial or residential table 900. to store the compressed and or shredded bottles 610. as shown in FIGS. 12 & 13

### Operation

The plastic bottle 100 is placed on the nozzle 105 with the nozzle 105 extending into the plastic bottle's neck. If the bottom assembly 20 is going to be used the bottom assembly 20 is attached to the main assembly 10 by an attachment means such as screwing it on the main assembly 10. The mount 130 will apply upward pressure on the plastic bottle 100 holding it in place while the retractable alignment rollers 310 will align the plastic bottle 100 for crushing. The vacuum means, such as the vacuum motor 60 will be turned on by the power switch 15 which will turn the vacuum fan blades 67 creating a vacuum in the plastic bottle 100 crushing it. The blade chopping motor 75 will then turn on turning the chopping blades 80 chopping the plastic bottle 100 into pieces forming compressed and or shredded bottles 610 ready for recycling. The bottle crusher can be positioned in various methods including trash can mount and table mount 800 and 900

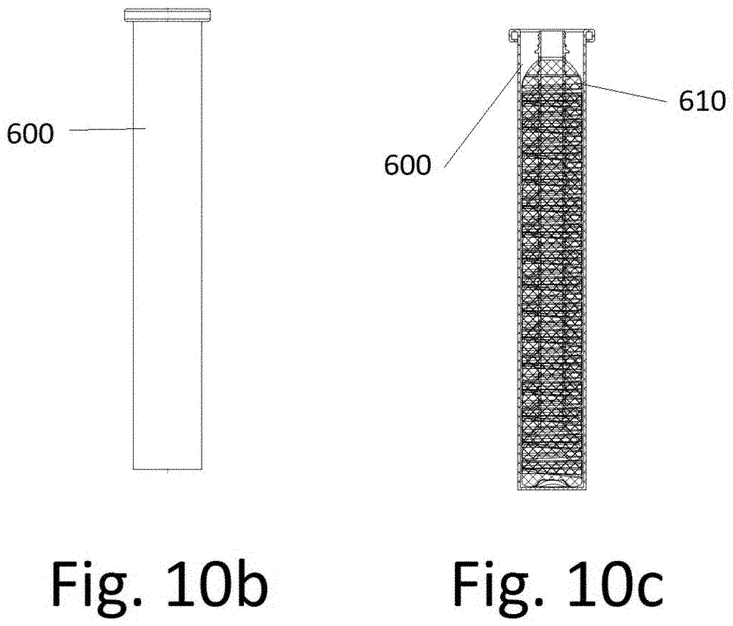

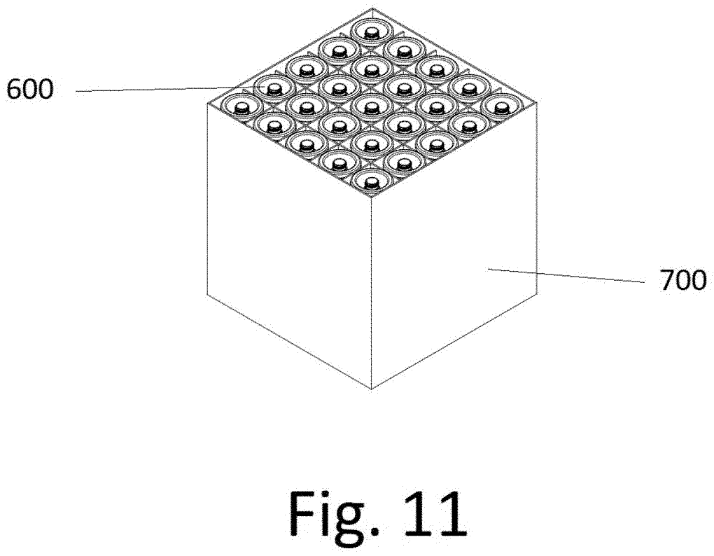

These compressed and or shredded bottles 610 can be loaded into a detachable sleeve bags 600 for easy transport to a recycling center as shown in FIGS. 10a-10c. A plurality of the round storage sleeve 600 can be loaded into a transport box 700 as shown in FIG. 11. As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A device for crushing plastic bottles comprising: a main assembly having a top and bottom with a vacuum means and a suction head at the bottom of the main assembly.

2. The device according to claim 1 further comprising having a bottom assembly attached to said main assembly.

3. The device according to claim 1 further comprising having a detachable shell.

4. The device according to claim 2 further comprising having a detachable shell.

5. The device according to claim 1 further comprising having a has a power switch and a power supply.

6. The device according to claim 1 where the vacuum means is a vacuum motor attached to a vacuum motor shaft which attaches to vacuum fan blades where the vacuum motor drives the vacuum motor shaft which turns the vacuum fan blades creating an upward air flow towards the top of the main assembly.

7. The device according to claim 1 further comprising having an exhaust air flow vent at the top of the main assembly.

8. The device according to claim 1 further comprising having a chopping motor where the chopping motor is attached to a chopping shaft which is connected to a plurality of chopping blades.

9. The device according to claim 1 where the suction head is adjustable.

10. The device according to claim 1 where the suction head is modular.

11. The device according to claim 1 where the suction head has a nozzle that extends away from the adjustable section head.

12. The device according to claim 11 where the nozzle is wider at its base where it connects to the adjustable section head and the nozzle tappers inward as it extends out.

13. The device according to claim 2 where the bottom assembly has a top side and said top side will have a transparent plastic access door with hinges.

14. The device according to claim 2 where the bottom assembly has an inner wall and a plurality of roller razors attached to said inner wall.

15. The device according to claim 2 where the bottom assembly has an inner wall and a plurality of retractable alignment rollers that extend inward from the inner wall to align and center the plastic bottle.

16. The device according to claim 2 where the bottom assembly has an inner wall and a plurality of label scrappers that out from the inner wall.

17. The device according to claim 2 where the bottom assembly has a bottom, where an end cap is placed on the bottom, where a spring loaded retractable mount is attached to the end cap.

18. A device for crushing plastic bottles comprising: a main assembly having a detachable shell, a top and bottom with a vacuum means and an adjustable suction head at the bottom of the main assembly where the vacuum means is a vacuum motor attached to a vacuum motor shaft which attaches to vacuum fan blades where the vacuum motor drives the vacuum motor shaft which turns the vacuum fan blades creating an upward air flow towards the top of the main assembly, having an exhaust air flow vent at the top of the main assembly, having a chopping motor where the chopping motor is attached to a chopping shaft which is connected to a plurality of chopping blades and where the power supply is separated from the vacuum motor by an exhaust vacuum filter.

19. The device according to claim 1 further comprising having a bottom assembly having a detachable and an inner wall with a plurality of retractable alignment rollers that extend inward from the inner wall to align and center the plastic bottle and a plurality of label scrappers that out from the inner wall, where the bottom assembly has a bottom with an end cap is placed on the bottom, where a spring loaded retractable mount is attached to the end cap and having a detachable sleeve bag.

20. A process to crush plastic bottles using the device according to claim 19.
